(19) United States
(12) Patent Application Publication
(10) Pub. No.: US 2024/0248510 A1
(43) Pub. Date: Jul. 25, 2024

(54) PROCESSING CIRCUIT AND NON-TRANSITORY COMPUTER READABLE MEDIUM STORING PROCESSING PROGRAM

(71) Applicant: FUJIFILM Business Innovation Corp., Tokyo (JP)

(72) Inventors: Masaki NUDEJIMA, Kanagawa (JP); Takayuki HASHIMOTO, Kanagawa (JP); Daiki TAKAZAWA, Kanagawa (JP)

(73) Assignee: FUJIFILM Business Innovation Corp., Tokyo (JP)

(21) Appl. No.: 18/358,028

(22) Filed: Jul. 25, 2023

(30) Foreign Application Priority Data
Jan. 20, 2023 (JP) 2023-007606

(51) Int. Cl. G06F 1/12; H04N 1/00

(52) U.S. Cl. CPC G06F 1/12; H04N 1/00933

(57) ABSTRACT

A processing circuit includes a calculation circuit that is sequentially connected, the calculation circuit including plural data holding units that hold plural pieces of data for each piece of data and one data calculation unit that is common to each of the data holding units and performs a predetermined calculation on each piece of data held in the data holding unit, in which a calculation result of the calculation circuit of a preceding stage is input to the data holding unit in the calculation circuit of a succeeding stage associated with data which is a calculation target in the calculation circuit of the preceding stage, and while the calculation circuit of the preceding stage performs the predetermined calculation on any piece of data, the calculation circuit of the succeeding stage performs the predetermined calculation on a calculation result obtained from another piece of data different from the data, which is the calculation target in the calculation circuit of the preceding stage, to perform the predetermined calculation on each piece of data.

### CROSS-REFERENCE TO RELATED APPLICATIONS

This application is based on and claims priority under 35 USC 119 from Japanese Patent Application No. 2023-007606 filed Jan. 20, 2023.

### BACKGROUND

### (i) Technical Field

The present disclosure relates to a processing circuit and a non-transitory computer readable medium storing a processing program.

### (ii) Related Art

JP2009-302812A describes an image scanning device having a one-pass double-sided simultaneous scanning mechanism that scans document images of front and back surfaces of a document with a single paper passing and a local memory that stores the scanned image data. The image scanning device includes an image data processing unit that performs the double-sided simultaneous scanning on the images of front and back surfaces using the one-pass double-sided simultaneous scanning mechanism, temporarily accumulates the scanned images in a local memory, and takes out the accumulated image to perform image processing or an image output. The image data processing unit scans, in a case where the processing is sequentially performed for each one surface, a plurality of consecutive images, accumulates the image data obtained by the scanning in the local memory, and processes, in a case where the image data is taken out from the local memory to perform the image processing or the image output, continuous front surfaces or continuous back surfaces as one frame.

### SUMMARY

A single processing circuit may perform predetermined processing on each of a plurality of pieces of data. In such a processing circuit, in a case where processing of input data ends and then processing of next data is started, processing performance deteriorates as compared with a case where each piece of data is processed in parallel.

Aspects of non-limiting embodiments of the present disclosure relate to a processing circuit that processes a plurality of pieces of data and a non-transitory computer readable medium storing a processing program capable of improving processing performance as compared with a case where processing of previous data ends and then processing of next data is started.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a processing circuit including a calculation circuit that is sequentially connected, the calculation circuit including plural data holding units that hold plural pieces of data for each piece of data and one data calculation unit that is common to each of the data holding units and performs a predetermined calculation on each piece of data held in the data holding unit, in which a calculation result of the calculation circuit of a preceding stage is input to the data holding unit in the calculation circuit of a succeeding stage associated with data which is a calculation target in the calculation circuit of the preceding stage, and while the calculation circuit of the preceding stage performs the predetermined calculation on any piece of data, the calculation circuit of the succeeding stage performs the predetermined calculation on a calculation result obtained from another piece of data different from the data, which is the calculation target in the calculation circuit of the preceding stage, to perform the predetermined calculation on each piece of data.

### BRIEF DESCRIPTION OF THE DRAWINGS

Exemplary embodiment(s) of the present invention will be described in detail based on the following figures, wherein:

FIG. 1 is a diagram showing a circuit configuration example using a processing group circuit;

FIG. 2 is a diagram showing an internal configuration example of a processing circuit;

FIG. 3 is a diagram showing an example of a time chart of the processing circuit;

FIG. 4 is a diagram showing a maximum configuration example of the processing circuit in a case where data is input every four clocks;

FIG. 5 is a diagram showing an internal configuration example of another processing circuit;

FIG. 6 is a diagram showing an example of a time chart of another processing circuit;

FIG. 7 is a diagram showing a configuration example of controlling the processing circuit by a computer; and

FIG. 8 is a flowchart showing an example of a flow of pipeline processing.

### DETAILED DESCRIPTION

Hereinafter, an exemplary embodiment of the present disclosure will be described in detail with reference to drawings. In addition, identical components and identical processing are denoted by identical reference numerals throughout the drawings, and redundant description will be omitted.

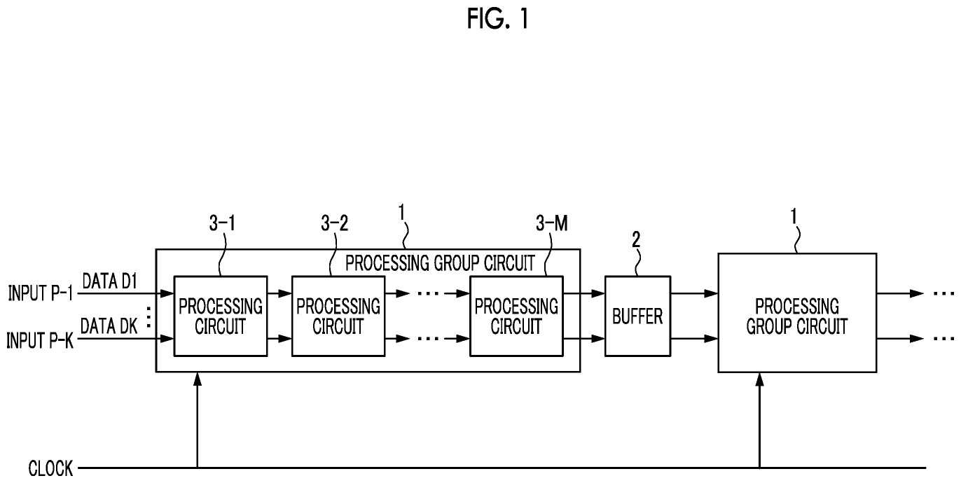

FIG. 1 is a diagram showing a circuit configuration example using a processing group circuit 1 that executes predetermined processing on input data D and outputs a processing result.

The processing group circuit 1 includes at least one processing circuit 3. The processing circuit 3 is a circuit that performs processing necessary for executing the predetermined processing in the processing group circuit 1. A circuit designer divides a content of the processing executed by the processing group circuit 1 into blocks and assigns, for example, the respective processing circuits 3 to the respective blocks. Then, the circuit designer sequentially connects the respective processing circuits 3 in consideration of an input and output of the processing circuit 3 such that the processing required in the processing group circuit 1 is executed, in designing the processing group circuit 1 that executes the predetermined processing.

The processing group circuit 1 shown in FIG. 1 includes M processing circuits 3. In the present exemplary embodiment, in a case where each processing circuit 3 is described in a distinguished manner, each processing circuit 3 is represented as “processing circuit 3-M”. In addition, “M” is an integer of one or more.

A plurality of pieces of data D are input to the processing group circuit 1, and the plurality of pieces of data D are first input to the processing circuit 3 of a first stage (processing circuit 3-1 in the case of the example of FIG. 1). The processing circuit 3 of the first stage is a processing circuit 3 to which the data D is first input in the processing group circuit 1.

The processing circuit 3 of the first stage in the processing group circuit 1 outputs a processing result to the processing circuit 3 of a succeeding stage (processing circuit 3-2 in the case of the example of FIG. 1) according to a connection state between the processing circuits 3. In a case where the processing result in the processing circuit 3 is input to the processing circuit 3 of a final stage (processing circuit 3-M in the case of the example in FIG. 1) in the processing group circuit 1 in this manner, a processing result by the processing circuit 3 of the final stage is output from the processing group circuit 1 as a processing result in the processing group circuit 1.

As shown in FIG. 1, the processing group circuit 1 may input the processing result to the processing group circuit 1 of a succeeding stage via, for example, a buffer 2 that temporarily stores the data D to adjust an input/output timing of the data D between the processing group circuits 1, and the processing may be continued.

Data D1 to data DK respectively input to the processing group circuit 1 from K inputs P-1 to P-K (where K is an integer of two or more) are simultaneously input to the processing group circuit 1 according to a predetermined timing. The term “data D is simultaneously input” means that each piece of data D is input within a range that can be regarded as simultaneous. That is, the term “simultaneous” does not refer to a specific moment in a time series, but includes a range having a time width.

In the present exemplary embodiment, in a case where the data D1 to the data DK are not necessary to be described in a distinguished manner, the data D1 to the data DK are represented as “data D”. In addition, in a case where the inputs P-1 to P-K are not necessary to be described in a distinguished manner, the inputs P-1 to P-K are represented as “input P”.

There is no limitation on a type of the data D input to the processing group circuit 1, and any type of data D may be used as long as the data D is simultaneously input according to the predetermined timing.

For example, the data D representing an image is input to the processing group circuit 1 from a scanner (not shown) that optically scans a content of a document to generate an image of the document. In a case where the scanner supports a double-sided scanning function of scanning contents of both sides of the document in one operation, respective pieces of data D representing images of front and back surfaces of the document are simultaneously input to the processing group circuit 1.

Further, a clock is input to the processing group circuit 1, and the processing group circuit 1 executes the processing in synchronization with the clock. That is, the predetermined timing at which the data D is input to the processing group circuit 1 is a timing according to a change in the clock. The clock is also input to each processing circuit 3 included in the processing group circuit 1, and the processing synchronized with the clock is also performed in each processing circuit 3. As described above, the processing group circuit 1 and the processing circuit 3 are examples of a synchronization circuit that operates in synchronization with the clock.

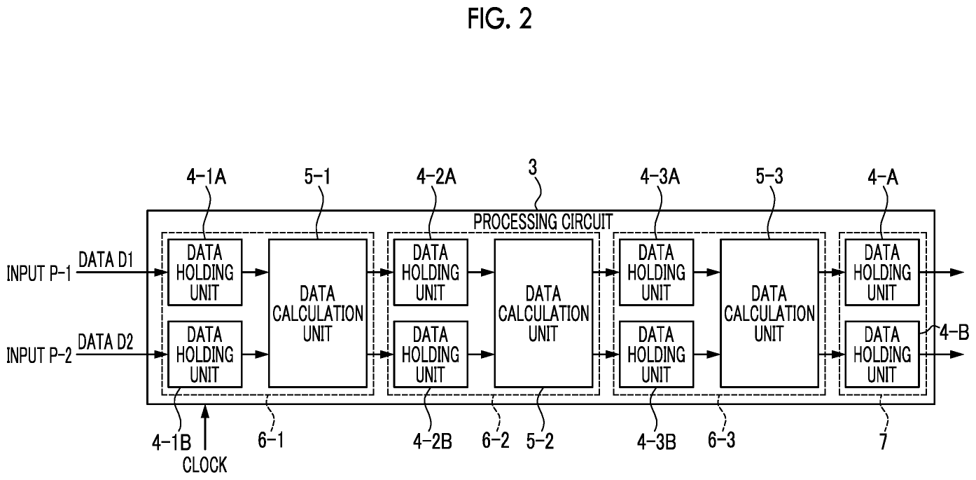

Next, the processing circuit 3 will be described. FIG. 2 is a diagram showing an internal configuration example of the processing circuit 3. For convenience of description, an example will be described in which the data D1 and the data D2 are input to the processing circuit 3 from two inputs P-1 and P-2, respectively.

The processing circuit 3 is configured by sequentially connecting calculation circuits 6 including a plurality of data holding units 4 that hold the plurality of pieces of data D for each piece of data D and a data calculation unit 5 that performs a predetermined calculation on each piece of data D held in the data holding unit 4. The term “sequentially connecting calculation circuits 6” means connecting the calculation circuits 6 in series, and is also referred to as “cascade connection”.

In the internal configuration example of the processing circuit 3 shown in FIG. 2, the processing circuit 3 includes three calculation circuits 6-1, 6-2, and 6-3, but there is no limitation on the number of the calculation circuits 6 included in the processing circuit 3. In the present exemplary embodiment, in a case where the calculation circuit 6-1 to the calculation circuit 6-3 are not necessary to be described in a distinguished manner, the calculation circuit 6-1 to the calculation circuit 6-3 are represented as “calculation circuit 6”.

The respective calculation circuits 6 are divided into units such that the calculation of the data D in the data calculation unit 5 ends within one clock.

In each calculation circuit 6, the respective data holding units 4 are connected to a common data calculation unit 5. Specifically, in the calculation circuit 6-1 of a first stage, a data holding unit 4-1A holding the data D1 and a data holding unit 4-1B holding the data D2 are connected to a data calculation unit 5-1 that performs the predetermined calculation on the data D1 and the data D2. The calculation circuit 6-1 of the first stage is a calculation circuit 6 to which the data D is first input in the processing circuit 3.

In the calculation circuit 6-2 of a second stage, a data holding unit 4-2A holding a calculation result of the data calculation unit 5-1 for the data D1 and a data holding unit 4-2B holding a calculation result of the data calculation unit 5-1 for the data D2 are connected to a data calculation unit 5-2. The calculation circuit 6-2 of the second stage is a calculation circuit 6 that receives the calculation results from the calculation circuit 6-1 of the first stage.

In the calculation circuit 6-3 of a third stage, a data holding unit 4-3A holding a calculation result obtained by further performing the calculation by the data calculation unit 5-2 on the calculation result of the data calculation unit 5-1 for the data D1 and a data holding unit 4-3B holding a calculation result obtained by further performing the calculation by the data calculation unit 5-2 on the calculation result of the data calculation unit 5-1 for the data D2 are connected to a data calculation unit 5-3. The calculation circuit 6-3 of the third stage is a calculation circuit 6 that receives the calculation results from the calculation circuit 6-2 of the second stage.

That is, the calculation circuit 6 includes the same number of the data holding units 4 as the number of the inputs P and one data calculation unit 5 common to the respective data holding units 4.

Further, the data calculation unit 5-1 in the calculation circuit 6-1 of the first stage is connected to the data holding unit 4-2A and the data holding unit 4-2B in the calculation circuit 6-2 of the second stage. The data calculation unit 5-2 in the calculation circuit 6-2 of the second stage is connected to the data holding unit 4-3A and the data holding unit 4-3B in the calculation circuit 6-3 of the third stage.

The calculation circuit 6-3, which is the final stage of the calculation circuit 6 in the processing circuit 3, is connected to a data holding unit 4-A of an output circuit 7 provided to output the calculation result for the data D1 from the processing circuit 3 and a data holding unit 4-B of the output circuit 7 provided to output the calculation result for the data D2 from the processing circuit 3.

As described above, the data holding unit 4 dedicated to each piece of data D is present in each calculation circuit 6 and the output circuit 7.

The data D1 and the data D2 are respectively input to the data holding unit 4-1A and the data holding unit 4-2B in the calculation circuit 6-1 at the same timing in synchronization with the clock.

In the data calculation unit 5-1 of the calculation circuit 6-1, the calculation results for respective pieces of data D are input to the data holding unit 4-2A and the data holding unit 4-2B corresponding to the respective pieces of data D in the calculation circuit 6-2 of the succeeding stage. As described above, in the data calculation unit 5 in the calculation circuit 6 of a preceding stage, the calculation result for each piece of data D is input to the data holding unit 4 corresponding to each piece of data D in the calculation circuit 6 of the succeeding stage or the output circuit 7.

In addition, the calculation result in the calculation circuit 6 of the preceding stage is input to each of the calculation circuits 6 other than the calculation circuit 6-1 of the first stage. However, the calculation result in the calculation circuit 6 of the preceding stage is also the same as the data D input to the calculation circuit 6 from the standpoint of the calculation circuit 6 of the succeeding stage. Therefore, in the following, in a case where the data D and the calculation result of the data D are not necessary to be distinguished, the calculation result in the calculation circuit 6 of the preceding stage may be represented as the data D.

Further, the data holding unit 4-1A to the data holding unit 4-3A, the data holding unit 4-1B to the data holding unit 4-3B, the data holding unit 4-A, and the data holding unit 4-B are not necessary to be described in a distinguished manner, the data holding units are represented as “data holding unit 4”.

Further, in a case where the data calculation unit 5-1 to the data calculation unit 5-3 are not necessary to be described in a distinguished manner, the data calculation unit 5-1 to the data calculation unit 5-3 are represented as “data calculation unit 5”.

The data calculation unit 5 includes a circuit that performs the same calculation on the data D as many as the number of pieces of input data D and includes only one circuit that performs the calculation on the data D, which does not support so-called parallel processing that simultaneously processes the plurality of pieces of data D held in the data holding unit 4. That is, at a specific point in time, the data calculation unit 5 performs only the calculation on any one of the pieces of data D held in each of the plurality of data holding units 4. Therefore, an area of the data calculation unit 5 can be suppressed to be smaller than an area required in a case where the parallel processing is supported.

Next, the processing of the data D in the processing circuit 3 including the calculation circuit 6 described above will be described in detail.

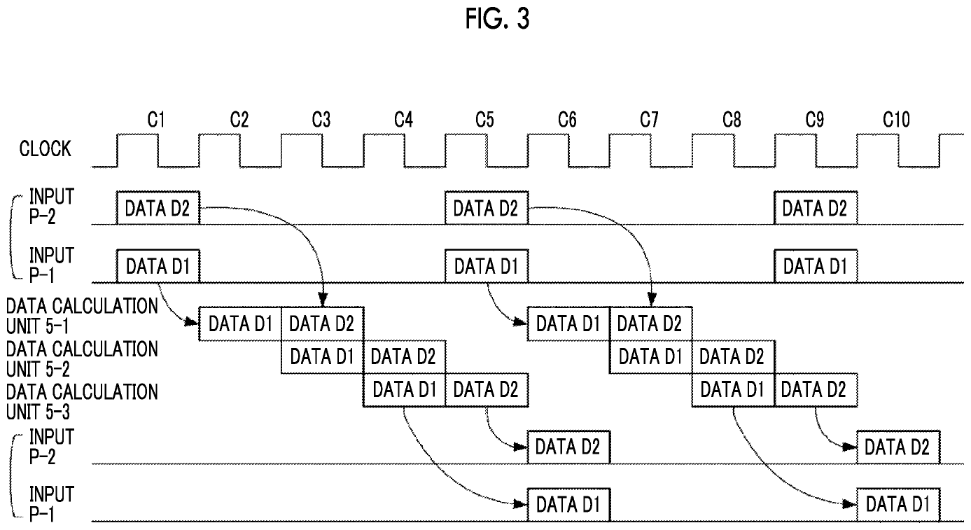

FIG. 3 is a diagram showing an example of a time chart of the processing executed by the processing circuit 3 shown in FIG. 2. The time chart of FIG. 3 shows a situation in which the data D1 and the data D2 are input to the processing circuit 3 every four clocks in synchronization with the clocks. Clocks C1 to C10 each represent clocks for one continuous clock.

In a case where the data D1 and the data D2 are respectively input from the input P-1 and the input P-2 in synchronization with the clock C1, the calculation circuit 6-1 holds the data D1 in the data holding unit 4-1A and holds the data D2 in the data holding unit 4-1B.

The data calculation unit 5-1 acquires the data D1 from the data holding unit 4-1A in synchronization with the clock C2, performs the predetermined calculation on the data D1, and stores the calculation result in the data holding unit 4-2A.

Since the calculation of the data D1 ends in the data calculation unit 5-1 during a period of the clock C2, the data calculation unit 5-1 acquires the data D2 from the data holding unit 4-1B in synchronization with the clock C3, performs the predetermined calculation on the data D2, and stores the calculation result in the data holding unit 4-2B.

On the other hand, since the data holding unit 4-2A of the calculation circuit 6-2 holds the calculation result in the calculation circuit 6-1, that is, the data D1, the data calculation unit 5-2 acquires the data D1 from the data holding unit 4-2A in synchronization with the clock C3, performs the predetermined calculation on the data D1, and stores the calculation result in the data holding unit 4-3A.

Since the calculation of the data D1 ends in the data calculation unit 5-2 during a period of the clock C3, the data calculation unit 5-2 acquires the calculation result in the calculation circuit 6-1, that is, the data D2 from the data holding unit 4-2B in synchronization with the clock C4, performs the predetermined calculation on the data D2, and stores the calculation result in the data holding unit 4-3B.

On the other hand, since the data holding unit 4-3A of the calculation circuit 6-3 holds the calculation result in the calculation circuit 6-2, that is, the data D1, the data calculation unit 5-3 acquires the data D1 from the data holding unit 4-3A in synchronization with the clock C4, performs the predetermined calculation on the data D1, and stores the calculation result in the data holding unit 4-A of the output circuit 7.

Since the calculation of the data D1 ends in the data calculation unit 5-3 during a period of the clock C4, the data calculation unit 5-3 acquires the calculation result in the calculation circuit 6-2, that is, the data D2 from the data holding unit 4-3B in synchronization with the clock C5, performs the predetermined calculation on the data D2, and stores the calculation result in the data holding unit 4-B of the output circuit 7.

At an end time point of the clock C5, the processing results in the processing circuit 3 are respectively held in the data holding units 4-A and the data holding units 4-B of the output circuit 7. Therefore, the processing circuit 3 outputs the data D1 and the data D2 held by the data holding units 4-A and the data holding units 4-B in synchronization with the clock C6. In a case where the processing circuit 3 of the succeeding stage is present for the processing circuit 3, the data D1 and the data D2 are input to the processing circuit 3 of the succeeding stage, and the operation described above is repeatedly executed in synchronization with the clock in the processing circuit 3 of the succeeding stage.

On the other hand, since the data D1 and the data D2 are input to the processing circuit 3 every four clocks, new pieces of data D1 and D2 are input to the processing circuit 3 from the input P-1 and the input P-2 in synchronization with the clock C5, respectively. Along with the above, the calculation circuit 6-1 holds the data D1 in the data holding unit 4-1A and holds the data D2 in the data holding unit 4-1B. Hereinafter, the processing circuit 3 repeatedly executes the operations described above in synchronization with the clock until the data D1 and the data D2 are no longer input.

In the time chart shown in FIG. 3, an example is shown in which each data calculation unit 5 performs the calculation on the data D1 and then performs the calculation on the data D2. However, there is no limitation on the calculation order of the data D, and the data D2 may be calculated and then the data D1 may be calculated.

As described above, in the processing circuit 3 of the present disclosure, the data calculation unit 5 included in each calculation circuit 6 performs the calculation on one piece of data D. Thus, the processing in the processing circuit 3 is divided into a plurality of parts, and each of the divided processing is assigned to each calculation circuit 6. Then, in the processing circuit 3, the calculation circuit 6 of the succeeding stage performs a predetermined calculation on a calculation result obtained from another piece of data D different from the data D to be calculated in the calculation circuit 6 of the preceding stage, while the calculation circuit 6 of the preceding stage performs the predetermined calculation on any piece of data D among the plurality of pieces of data D simultaneously input to the processing circuit 3.

That is, paying attention to the individual data calculation units 5, at a specific moment in a time series, the data calculation unit 5 performs only the calculation on any one piece of data D among the plurality of pieces of input data D. However, since each data calculation unit 5 performs pipeline processing synchronized with the clock, the processing circuit 3 performs the processing on the plurality of pieces of input data D in duplicate.

Therefore, the processing performance of the processing circuit 3 is improved as compared with a case where the processing circuit 3 ends the processing on any piece of data D among the plurality of pieces of input data D and then starts the processing of next data D.

Even though the data holding unit 4 of the calculation circuit 6 is prepared in accordance with the number of pieces of data D simultaneously input to the processing circuit 3, in a case where the number of pieces of data D simultaneously input to the processing circuit 3 exceeds the number of clocks corresponding to an input interval of the data D input to the processing circuit 3, the data D that is overwritten by new data D, without being calculated by the calculation circuit 6-1, is generated among the pieces of data D held in the data holding unit 4 of the calculation circuit 6-1.

Therefore, the number of pieces of data D simultaneously input to the processing circuit 3 is limited to the number of clocks or less, which corresponds to the input interval of the data D input to the processing circuit 3. In the processing circuit 3 that processes the data D input every four clocks as in the time chart shown in FIG. 3, even in a case where a maximum of four pieces of data D1 to D4 are simultaneously input, the predetermined processing can be executed on each piece of data D.

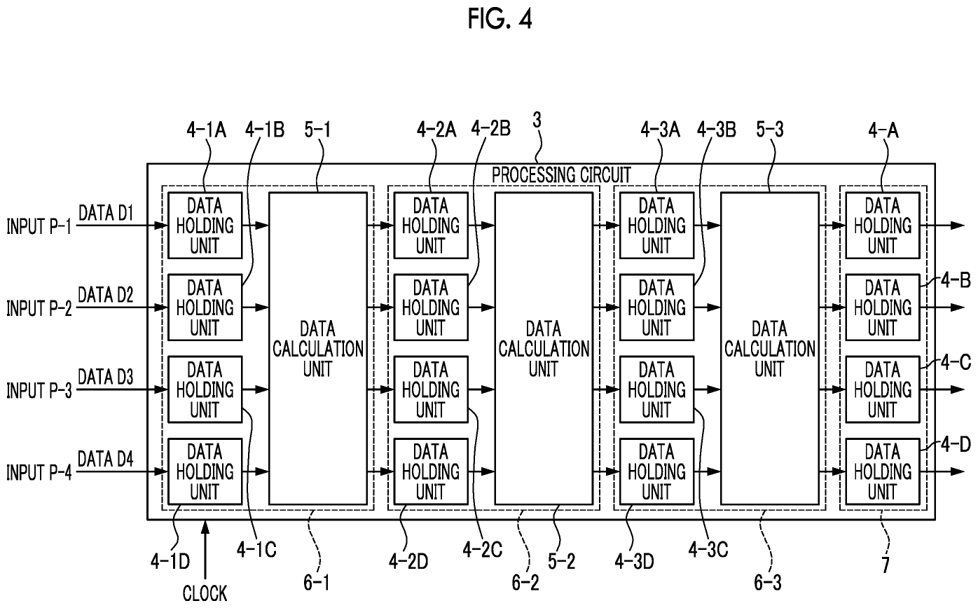

FIG. 4 is a diagram showing an internal configuration example in a case where the processing circuit 3 shown in FIG. 2 supports inputs of the four pieces of data D1 to D4. In this case, there are four data holding units 4 of each calculation circuit 6 and four data holding units 4 of the output circuit 7.

### Modification Example of Processing Circuit

The same number of the data holding units 4 included in each calculation circuit 6 and the output circuit 7 in the processing circuits 3 shown in FIGS. 2 and 4 as the number of pieces of data D input to the processing circuits 3 are prepared. However, in a case where the data calculation unit 5 executes processing, within one clock, of acquiring the data D from the data holding unit 4, performing the predetermined calculation on the acquired data D, and storing the calculation result in the data holding unit 4 in the calculation circuit 6 of the succeeding stage or the data holding unit 4 in the output circuit 7, even in the data holding unit 4 in which the data D is held, the data D is taken out after one clock and an empty state is made.

Therefore, in a case where one data holding unit 4 is provided for the calculation circuit 6 of the second and succeeding stages, which is the calculation circuit 6 other than the calculation circuit 6-1 of the first stage, and for the output circuit 7, respectively, a situation does not occur in which the held data D is overwritten by new data D before the data D is taken out from the data holding unit 4.

Since the plurality of pieces of data D are simultaneously input to the calculation circuit 6-1 of the first stage in the processing circuit 3, the calculation circuit 6-1 of the first stage includes the same number of the data holding units 4 as the number of pieces of data D simultaneously input.

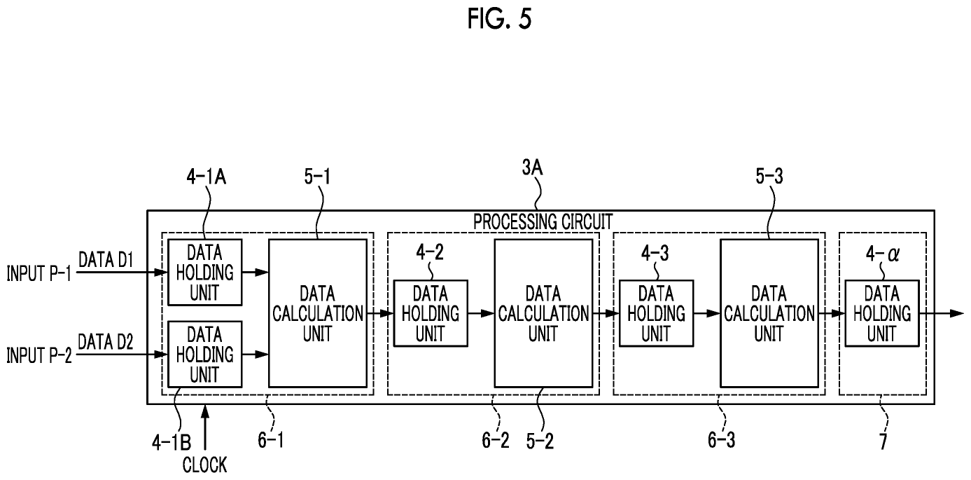

FIG. 5 shows an internal configuration example of a processing circuit 3A having one data holding unit 4 in the calculation circuit 6 of the second and succeeding stages and one data holding unit 4 in the output circuit 7, in the processing circuit 3 shown in FIG. 2.

As shown in FIG. 5, the calculation circuit 6-2 in the processing circuit 3A includes a data holding unit 4-2, and the calculation circuit 6-3 includes a data holding unit 4-3. Further, the output circuit 7 includes a data holding unit 4-α.

Next, processing of the data D in the processing circuit 3A shown in FIG. 5 will be described in detail.

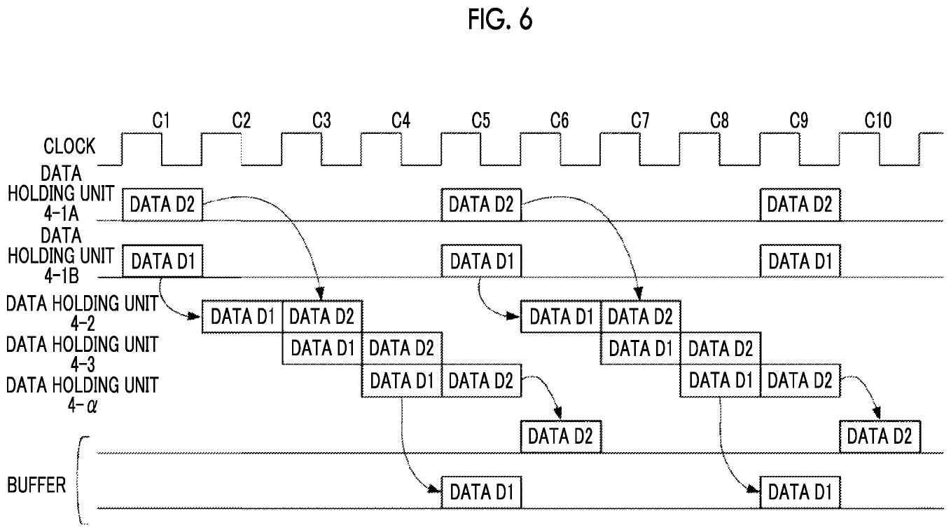

FIG. 6 is a diagram showing an example of a time chart of the processing executed by the processing circuit 3A shown in FIG. 5. As in the time chart shown in FIG. 3, the time chart of FIG. 6 shows a situation in which the data D1 and the data D2 are input to the processing circuit 3A every four clocks in synchronization with clocks.

The time chart shown in FIG. 6 shows the data D, for each clock, held in each data holding unit 4 at an end time point of each clock.

In a case where the data D1 and the data D2 are respectively input from the input P-1 and the input P-2 in synchronization with the clock C1, the calculation circuit 6-1 holds the data D1 in the data holding unit 4-1A and holds the data D2 in the data holding unit 4-1B.

The data calculation unit 5-1 acquires the data D1 from the data holding unit 4-1A in synchronization with the clock C2, performs the predetermined calculation on the data D1, and stores the calculation result in the data holding unit 4-2.

The data calculation unit 5-2 acquires the data D1 from the data holding unit 4-2 in synchronization with the clock C3, performs the predetermined calculation on the data D1, and stores the calculation result in the data holding unit 4-3.

That is, the data D1 held in the data holding unit 4-2 is taken out by the data calculation unit 5-2 at the start of the clock C3. Therefore, the data calculation unit 5-1 acquires the data D2 from the data holding unit 4-1B in synchronization with the clock C3, performs the predetermined calculation on the data D2, and stores the calculation result in the data holding unit 4-2.

The data calculation unit 5-3 acquires the data D1 from the data holding unit 4-3 in synchronization with the clock C4, performs the predetermined calculation on the data D1, and stores the calculation result in the data holding unit 4-α.

That is, the data D1 held in the data holding units 4-3 is taken out by the data calculation unit 5-3 at the start of the clock C4. Therefore, the data calculation unit 5-2 acquires the data D2 from the data holding unit 4-2 in synchronization with the clock C4, performs the predetermined calculation on the data D2, and stores the calculation result in the data holding unit 4-3.

In synchronization with the clock C5, the processing circuit 3A outputs the data D1 held in the data holding units 4-α to the buffer 2.

That is, the data D1 held in the data holding units 4-α is taken out by the processing circuit 3A at the start of the clock C5. Therefore, the data calculation unit 5-3 acquires the data D2 from the data holding unit 4-3 in synchronization with the clock C5, performs the predetermined calculation on the data D2, and stores the calculation result in the data holding unit 4-α.

In synchronization with the clock C6, the processing circuit 3A outputs the data D2 held in the data holding unit 4-α to the buffer 2.

In a case where the processing circuit 3A of a succeeding stage is present for the processing circuit 3A, the data D1 and the data D2 are simultaneously input to the processing circuit 3A of the succeeding stage via the buffer 2, and the operation described above is repeatedly executed in synchronization with the clock in the processing circuit 3A of the succeeding stage.

On the other hand, since the data D1 and the data D2 are input to the processing circuit 3A every four clocks, new pieces of data D1 and D2 are input to the processing circuit 3A from the input P-1 and the input P-2 in synchronization with the clock C5, respectively. Along with the above, the calculation circuit 6-1 holds the data D1 in the data holding unit 4-1A and holds the data D2 in the data holding unit 4-1B. Hereinafter, in the processing circuit 3A, the operation described above is repeatedly executed in synchronization with the clock until the data D1 and the data D2 are no longer input.

As described above, in the processing circuit 3A of the present disclosure, each calculation circuit 6 performs processing, within one clock, of taking out the data held in the data holding unit 4, performing the predetermined calculation on the taken out data D, and storing the calculation result in the data holding unit 4 in the calculation circuit 6 of the succeeding stage or the data holding unit 4 in the output circuit 7, before next data D is input to the data holding unit 4 of the calculation circuit 6.

Therefore, even in a case where one data holding unit 4 is provided for the calculation circuit 6 other than the calculation circuit 6-1 of the first stage and for the output circuit 7, respectively, the processing circuit 3A performs the processing on the plurality of pieces of input data D in duplicate.

Up to this point, an example has been described in which the processing circuit 3 and the processing circuit 3A respectively execute the pipeline processing shown in FIG. 3 and FIG. 6 in synchronization with the clock. However, a computer 10 may control the processing circuit 3 and the processing circuit 3A to cause the processing circuit 3 and the processing circuit 3A to respectively execute the pipeline processing shown in FIG. 3 and FIG. 6. Hereinafter, the processing circuit 3 and the processing circuit 3A are represented as “processing circuits 3 and 3A”, and the processing circuit 3 or the processing circuit 3A is represented as “processing circuit 3 (3A)”.

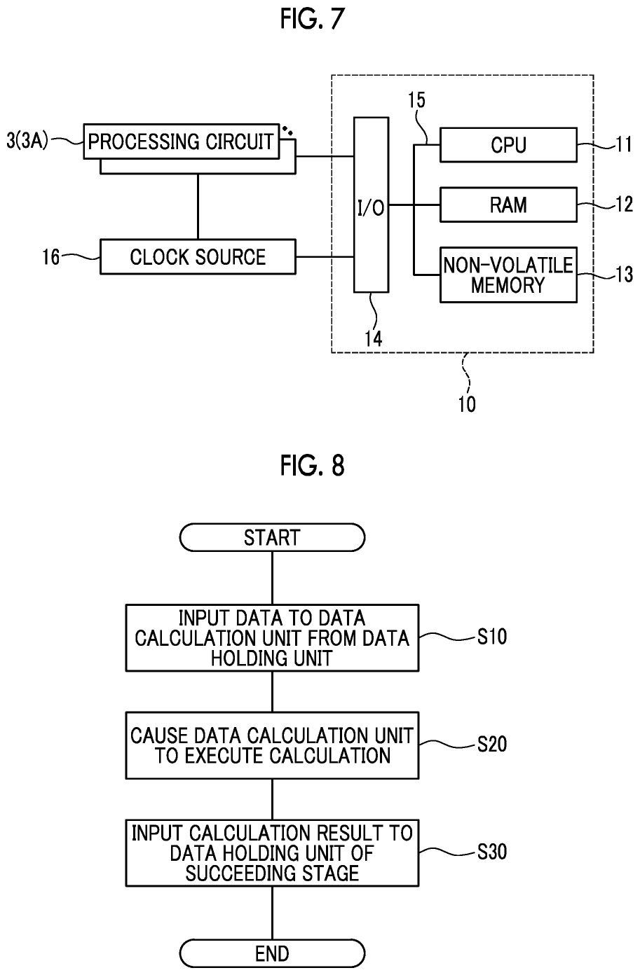

FIG. 7 is a diagram showing a configuration example of controlling the processing circuit 3 (3A) by the computer 10.

The computer 10 includes a central processing unit (CPU) 11 which is an example of a processor, a random access memory (RAM) 12 used as a temporary work area of the CPU 11, a non-volatile memory 13, and an input/output interface (I/O) 14. The CPU 11, the RAM 12, the non-volatile memory 13, and the I/O 14 are connected to each other via a bus 15.

The non-volatile memory 13 is an example of a storage device that retains stored information even in a case where power supplied to the non-volatile memory 13 is cut off, and for example, a semiconductor memory is used, but a hard disk may be used.

For example, at least one processing circuit 3 (3A) and a clock source 16 are connected to the I/O 14.

The clock source 16 is a device that supplies a clock to the processing circuit 3 (3A) and the computer 10. For example, a ceramic oscillator or a crystal oscillator is used.

FIG. 8 is a flowchart showing an example of a flow of the pipeline processing executed by the CPU 11 of the computer 10 in a case where the data D is input to the processing circuit 3.

A processing program that defines the pipeline processing is stored in advance in, for example, the non-volatile memory 13 of the computer 10. The CPU 11 reads the processing program stored in the non-volatile memory 13 to execute the pipeline processing. The pipeline processing shown in FIG. 8 is started in synchronization with the clock and ends within one clock.

In step S10, the CPU 11 inputs the data D to the data calculation unit 5 from any one of the data holding units 4 of the calculation circuit 6 to which the data D is input.

In step S20, the CPU 11 causes the data calculation unit 5 to execute the predetermined calculation on the data D.

In step S30, the CPU 11 inputs the calculation result to the data holding unit 4 corresponding to the data D to be calculated among the data holding unit 4 provided for each piece of data D in the calculation circuit 6 of the succeeding stage or the data holding unit 4 provided for each piece of data D in the output circuit 7.

The CPU 11 executes the processing shown in steps S10 to S30 for each calculation circuit 6 to which the data D is input. In a case where the data D is input to the data holding unit 4 of the output circuit 7, the CPU 11 takes out the data D from the data holding unit 4 of the output circuit 7 and outputs the data D to the outside of the processing circuit 3.

Although the pipeline processing of the processing circuit 3 has been described above with reference to FIG. 8, the CPU 11 also executes the pipeline processing of the processing circuit 3A according to the flowchart shown in FIG. 8.

In the processing circuit 3A, only one data holding unit 4 is included in the calculation circuit 6 of the second and succeeding stages. Thus, the CPU 11 may input the data D from the one data holding unit 4 to the data calculation unit 5 for the calculation circuit 6 of the second and succeeding stages in step S10. Further, since the calculation circuit 6 of the succeeding stage and the output circuit 7 also include only one data holding unit 4, the CPU 11 may input the calculation result to the one data holding unit 4 in step S30.

Although one aspect of the processing circuits 3 and 3A is described above by using the exemplary embodiment, the exemplary embodiments of the disclosed processing circuits 3 and 3A are examples, and the exemplary embodiments of the processing circuits 3 and 3A are not limited to the scope described in the exemplary embodiment. Various modifications and improvements can be added to the exemplary embodiments without departing from the gist of the present disclosure, and the exemplary embodiments to which the modifications or improvements are added are also included in the technical scope of the present disclosure.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

In the above exemplary embodiment, in a case where the CPU 11 executes the pipeline processing of the processing circuits 3 and 3A, the processing program stored in the non-volatile memory 13 is read and executed. However, the storage destination of the processing program is not limited to the non-volatile memory 13. The processing program of the present disclosure can also be provided in a form of being recorded on a storage medium readable by the computer 10.

For example, the processing program may be provided in a form of being recorded on optical discs such as a compact disk read only memory (CD-ROM), a digital versatile disk read only memory (DVD-ROM), and a Blu-ray disk. Alternatively, the processing program may be provided in a form of being recorded on portable semiconductor memories such as a universal serial bus (USB) memory and a memory card. The non-volatile memory 13, the CD-ROM, the DVD-ROM, the Blu-ray disk, the USB, and the memory card are examples of a non-transitory storage medium.

Further, the computer 10 may download the processing program from an external device connected to a communication line through a communication unit (not shown) and store the downloaded processing program in the non-volatile memory 13. In this case, the CPU 11 reads, from the non-volatile memory 13, the processing program downloaded from the external device and executes the pipeline processing.

Supplementary notes according to the present exemplary embodiment are shown below.
(((1)))

A processing circuit comprising:
a calculation circuit that is sequentially connected, the calculation circuit including a plurality of data holding units that hold a plurality of pieces of data for each piece of data and one data calculation unit that is common to each of the data holding units and performs a predetermined calculation on each piece of data held in the data holding unit,
wherein a calculation result of the calculation circuit of a preceding stage is input to the data holding unit in the calculation circuit of a succeeding stage associated with data which is a calculation target in the calculation circuit of the preceding stage, and
while the calculation circuit of the preceding stage performs the predetermined calculation on any piece of data, the calculation circuit of the succeeding stage performs the predetermined calculation on a calculation result obtained from another piece of data different from the data, which is the calculation target in the calculation circuit of the preceding stage, to perform the predetermined calculation on each piece of data.
(((2)))

A processing circuit comprising:
a calculation circuit that is sequentially connected, the calculation circuit including a data holding unit that holds data and a data calculation unit that performs a predetermined calculation on the data held in the data holding unit,
wherein the calculation circuit of a first stage to which data is first input includes the data holding unit of the same number as the number of pieces of data input simultaneously and other calculation circuits each include one data holding unit, and
each of the calculation circuits performs processing of taking out, before next data is input to the data holding unit, the data held in the data holding unit, performing the predetermined calculation on the taken out data, and storing a calculation result in the data holding unit of the calculation circuit of a succeeding stage.
(((3)))

The processing circuit according to (((1))) or (((2))),
wherein the calculation circuit is a synchronization circuit that synchronizes with a clock, and
the calculation circuit is divided such that the calculation in the data calculation unit ends within one clock.
(((4)))

The processing circuit according to (((3))),
wherein each piece of data is input to the data holding unit of the calculation circuit of a first stage to which data is first input, at the same timing in synchronization with the clock.
(((5)))

The processing circuit according to (((4))),
wherein the number of pieces of data is limited to the number of clocks or less, which corresponds to an input interval of the data input to the calculation circuit of a first stage.
(((6)))

A non-transitory computer readable medium storing a processing program causing a computer to execute a process comprising:
for a processing circuit including a calculation circuit that is sequentially connected, the calculation circuit including a plurality of data holding units that hold a plurality of pieces of data for each piece of data and one data calculation unit that is common to each of the data holding units and performs a predetermined calculation on each piece of data held in the data holding unit,
inputting a calculation result of the calculation circuit of a preceding stage to the data holding unit in the calculation circuit of a succeeding stage associated with data, which is a calculation target in the calculation circuit of the preceding stage; and
while the calculation circuit of the preceding stage performs the predetermined calculation on any piece of data, performing, by the calculation circuit of the succeeding stage, the predetermined calculation on a calculation result obtained from another piece of data different from the data, which is the calculation target in the calculation circuit of the preceding stage, to perform the predetermined calculation on each piece of data.
(((7)))

A processing program causing a computer to execute a process comprising:
for a processing circuit including a calculation circuit that is sequentially connected, the calculation circuit including a data holding unit that holds data and a data calculation unit that performs a predetermined calculation on the data held in the data holding unit,
wherein the calculation circuit of a first stage to which data is first input includes the data holding unit of the same number as the number of pieces of data input simultaneously and other calculation circuits each include one data holding unit,
performing, by each of the calculation circuits, processing of taking out, before next data is input to the data holding unit, the data held in the data holding unit, performing the predetermined calculation on the taken out data, and storing a calculation result in the data holding unit of the calculation circuit of a succeeding stage.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A processing circuit comprising:
a calculation circuit that is sequentially connected, the calculation circuit including a plurality of data holding units that hold a plurality of pieces of data for each piece of data and one data calculation unit that is common to each of the data holding units and performs a predetermined calculation on each piece of data held in the data holding unit,
wherein a calculation result of the calculation circuit of a preceding stage is input to the data holding unit in the calculation circuit of a succeeding stage associated with data which is a calculation target in the calculation circuit of the preceding stage, and
while the calculation circuit of the preceding stage performs the predetermined calculation on any piece of data, the calculation circuit of the succeeding stage performs the predetermined calculation on a calculation result obtained from another piece of data different from the data, which is the calculation target in the calculation circuit of the preceding stage, to perform the predetermined calculation on each piece of data.

2. A processing circuit comprising:
a calculation circuit that is sequentially connected, the calculation circuit including a data holding unit that holds data and a data calculation unit that performs a predetermined calculation on the data held in the data holding unit,
wherein the calculation circuit of a first stage to which data is first input includes the data holding unit of the same number as the number of pieces of data input simultaneously and other calculation circuits each include one data holding unit, and
each of the calculation circuits performs processing of taking out, before next data is input to the data holding unit, the data held in the data holding unit, performing the predetermined calculation on the taken out data, and storing a calculation result in the data holding unit of the calculation circuit of a succeeding stage.

3. The processing circuit according to claim 1,
wherein the calculation circuit is a synchronization circuit that synchronizes with a clock, and
the calculation circuit is divided such that the calculation in the data calculation unit ends within one clock.

4. The processing circuit according to claim 2,
wherein the calculation circuit is a synchronization circuit that synchronizes with a clock, and
the calculation circuit is divided such that the calculation in the data calculation unit ends within one clock.

5. The processing circuit according to claim 3,
wherein each piece of data is input to the data holding unit of the calculation circuit of a first stage to which data is first input, at the same timing in synchronization with the clock.

6. The processing circuit according to claim 4,
wherein each piece of data is input to the data holding unit of the calculation circuit of the first stage to which data is first input, at the same timing in synchronization with the clock.

7. The processing circuit according to claim 5,
wherein the number of pieces of data is limited to the number of clocks or less, which corresponds to an input interval of the data input to the calculation circuit of a first stage.

8. The processing circuit according to claim 6,
wherein the number of pieces of data is limited to the number of clocks or less, which corresponds to an input interval of the data input to the calculation circuit of the first stage.

9. A non-transitory computer readable medium storing a processing program causing a computer to execute a process comprising:
for a processing circuit including a calculation circuit that is sequentially connected, the calculation circuit including a plurality of data holding units that hold a plurality of pieces of data for each piece of data and one data calculation unit that is common to each of the data holding units and performs a predetermined calculation on each piece of data held in the data holding unit,
inputting a calculation result of the calculation circuit of a preceding stage to the data holding unit in the calculation circuit of a succeeding stage associated with data, which is a calculation target in the calculation circuit of the preceding stage; and
while the calculation circuit of the preceding stage performs the predetermined calculation on any piece of data, performing, by the calculation circuit of the succeeding stage, the predetermined calculation on a calculation result obtained from another piece of data different from the data, which is the calculation target in the calculation circuit of the preceding stage, to perform the predetermined calculation on each piece of data.
